(19) United States
(12) Patent Application Publication
(10) Pub. No.: US 2019/0342019 A1
(43) Pub. Date: Nov. 7, 2019

(54) MEDIA PLAYER WITH MULTIFUNCTIONAL CROSSFADER

(71) Applicant: SOUNDIO AS, Drammer (NO)

(72) Inventors: Pål WAGTSKJOLD-MYRAN, Bergen (NO); Henrik Gunnar SUNDT, Oslo (NO)

(73) Assignee: SOUNDIO AS, Drammer (NO)

(21) Appl. No.: 16/310,237

(22) PCT Filed: Jun. 14, 2017
(86) PCT No.: PCT/NO2017/050159

§ 371 Date: Dec. 14, 2018

(30) Foreign Application Priority Data
Jun. 16, 2016 (NO) 20161022

(51) Int. Cl. H04H 60/04; G06F 9/451; G06F 3/16

(52) U.S. Cl. CPC H04H 60/04; G06F 3/165; G06F 9/451

(57) ABSTRACT

A method of executing a transition from playback of a first audio track to playback of a second audio track on an electronic device. The method will, during playback of the first audio track, initiate an execution of a transition from the first audio track to the second audio track. During the transition, any sound effect referred to in a transition definition will be executed in accordance with position marks and parameters included in the transition definition. Upon receiving a positional value generated from user input representative of a modification of a position in the transition, the progression of the transition will be continuously modified in accordance with the received user input in accordance with rules that determine how sound effects should be executed when such user input is received. In the absence of user input, the positional value may be continually updated based on a clock or a counter.

### TECHNICAL FIELD

The present invention relates to a digital media player, and in particular to a media player with multifunctional crossfader capabilities.

### BACKGROUND

Digital media players capable of reproducing audio were introduced a few decades ago in the form of software for personal computers as well as dedicated devices from manufacturers like Diamond Multimedia, Creative Technology Ltd., and Apple Computer. The dedicated devices have largely been replaced by software apps for smartphones, often capable of cooperating with online streaming services and dedicated wireless media systems. This capability has largely been introduced in digital media applications for personal computers as well.

Many digital media players include a capability of creating playlists that include a number of tracks that can be played in a predefined or randomized sequence. Such playlists can often be shared with other users of the same or similar players or cloud based services.

In the world of public entertainment, particularly as provided by disc jockeys (DJs), it is not uncommon to combine the presentation of prerecorded music with various audio effects. As such, a DJ may add sound processing effects such as, for example, echo, reverb and phasing, fade tracks in and out, speed tracks up or slow them down, for example in order to synchronize the beat or tempo, of two audio tracks, and add pre-recorded sounds such as horns, whistles, bangs, applause etc. These capabilities have, however, mostly been available in professional PA systems and studio equipment, and to a certain extent in amateur equivalents that emulate the functionality and operating mode of professional equipment. A number of products that combine professional sound effects with a simplified user interface are available, but the available modes of operation are still limited.

Consequently, there is a need for media players that can provide some of the functionality of a professional DJ system to consumer media players, and in particular to media players that are capable of creating or playing predefined playlists of audio or media tracks.

### SUMMARY OF THE DISCLOSURE

The present invention aims at addressing this need by providing a method of executing a transition from playback of a first audio track to playback of a second audio track on an electronic device. During playback of the first audio track, execution of a transition from the first audio track to the second audio track is initiated, and any sound effect referred to in a transition definition is executed in accordance with position marks and parameters included in the transition definition. Whenever a positional value generated from user input and representative of a change of a current position in the transition is received, the progression of the transition may be controlled in accordance with the received user input. The modification of the progression is continuous as long as modified positional values are received.

According to some embodiments, rules that determine how the sound effects should be executed are applied based on the received user input.

In some embodiments, a user interface window is generated. The user interface window includes a transition control element, and the positional value is generated from user manipulation of this transition control element. The transition control element may be moved between positions ranging from a position representing the beginning of the transition defined in the transition definition to a position representing the end of the transition defined in the transition definition.

The position representing the beginning of the transition can be associated with a positional value of 0, and the position representing the end of the transition definition can be associated with a positional value of 1. Intermediate positions will then be associated with values between 0 and 1 as determined by the relative distance to the position representing the beginning of the transition and the position representing the end of the transition. The progression of the transition can then be modified based on a multiplication of the length of the transition as determined from the transition definition with the positional value.

Embodiments of the invention may implement sound effects in the form of one or both of filters, which subject an audio track to digital signal processing in accordance with a filter definition and parameters defined in said transition definition, and audio samples, which are pre-recorded sound effects which can be played back in a mix with said audio tracks.

A filter, which is invoked at one or more discrete points during the progression of the transition, may continue to receive parameter values after, or between, such invocations in accordance with one or more rules selected from the group consisting of: no value; closest past (previous) value; closest value (whether previous or next); closest future (next) value; last specified value; and an interpolated value (e.g. an interpolation between closest past and closest future value).

Playback of an audio sample is determined in accordance with rules selected form the group consisting of: forward; backward normal; backward reversed; loop; and loop when frozen (where forward and backward are relative to the beginning and the end of the transition).

In some embodiments, transition definitions are in the form of scripts that are stored in a script library and that can be loaded into the transition control module by a script module. Alternatively, transition definitions may be coded into the program code of the transition control module. Some embodiments may, of course, implement both alternatives, where a transition definition coded into the transition control module is used in the absence of a loaded transition definition script.

Some embodiments of the invention may implement automatic progression of transitions in the absence of relevant user input. In these embodiments the transition progresses in accordance with a positional value generated by a clock or a counter counting time units in the absence of a positional value generated from user input. The position marks in the transition definition may then be in the form of time stamps, and the position in the transition is a temporal position.

Embodiments of the invention may also control progression of the transition based on a positional value generated by a counter counting beats of music included in at least one of the audio tracks in the absence of any positional value generated from user input.

Transition definitions may be in a human readable script or in binary code.

In another aspect of the invention an electronic device configured for playing back audio tracks and executing transitions between tracks in accordance with definitions in a transition definition is provided. Such a device may include a transition control module configured to control a transition in accordance with a transition definition including references to sound effects associated with position marks and parameters and by comparing said position marks with a current position. A sound effects module may be configured to receive audio data representing audio tracks and to receive effect control data from the transition control module and execute sound effects defined in the received effect control data by processing the audio data in accordance with the sound effects defined in the received effect control data. A position control module is configured to deliver a positional value representative of a current position in a transition to the transition control module. A user interface module is capable of receiving user input representative of a modification of a current position in the transition, and of providing said user input to said position control module.

The position control module may be further configured to convert received user input to the positional value that can be forwarded to the transition control module, and the transition control module may then modify progression of the transition in accordance with the positional value.

In some embodiments, a rules module is configured to provide the transition control module with rules that determine how sound effects should be executed. The transition control module modifies the application of the sound effects based on the rules received from the rules module and the positional value received from the position control module (303).

In some embodiments the user interface module may be configured to generate a user interface window including a transition control element and to provide a value representative of the position in the user interface window of the transition control element to the position control module as said user input. The transition control element can be moved between positions ranging from a position representing the beginning of the transition defined in the transition definition and to a position representing the end of the transition defined in the transition definition. The position control module may be configured to convert the value provided by the user interface module to a positional value of 0 when the transition control element is at a position representing the beginning of the transition, to a positional value of 1 when the transition control element is at a position representing the end of the transition, and intermediate positions are converted to positional values between 0 and 1 determined by the relative position of the transition control element between the position representing the beginning of the transition and the position representing the end of the transition.

The sound effects module may be configured to perform digital signal processing of the received audio data in order to implement one or more of the sound effects such as filters, which subject audio data to digital signal processing in accordance with a filter definition and parameters defined in said transition definition, and audio samples, which are pre-recorded sound effects which can be played back in a mix with said other audio data.

In some embodiments the transition control module may be configured to continually calculate parameter values for filters that have been invoked in the transition definition and provide these parameter values as effect control data to the sound effects module during the progression of the transition. The calculated parameter values may be based on one or more rules, such as no value, closest past value, closest value, closest future value, last specified value, and an interpolated value.

The transition control module may be configured to provide effect control data to the sound effects module during the progression of the transition such that playback of an audio sample is determined in accordance with rules such as forward, backward normal, backward reversed, loop, and loop when frozen.

In order to provide the user with a selection of transition definitions to choose from, some embodiments comprise a script library in which transition definitions are stored as script files, and a script module which is configured to load script files from the script library to the transition control module. As an alternative, or supplement, to scripts in a library, the transition control module may be configured to control a transition based on a transition definition which is coded into the program code of the transition control module.

In some embodiments the position control module comprises a clock or a counter counting time units, and the position control module is configured to generate a positional value based on said clock or counter in the absence of any positional value generated from user input. Some embodiments also implement, in the position control module (303), a counter counting beats of music included in at least one of said first audio track and said second audio track. The position control module may then be configured to generate a positional value based on this counter in the absence of any positional value generated from user input.

According to yet another aspect of the invention, a computer program product is provided, including computer readable medium readable by a computing device and including instructions enabling the computing device with a processor to perform a method described above.

### BRIEF DESCRIPTION OF THE DRAWINGS

A more detailed explanation of the invention will now be presented in the form of examples and with reference to the appended drawings, wherein

FIG. 1 is an overview of a networked system that may be used to implement the invention:

FIG. 2 illustrates an exemplary configuration of some of the modules of a device implementing the invention;

FIGS. 3A and 3B are block diagrams showing various modules of an embodiment of the invention;

FIG. 4 shows an exemplary user interface of an embodiment of the invention;

FIG. 5 shows an example of a transition from one audio track to another;

FIG. 6 is a flow chart illustrating internal states of and steps performed by an exemplary embodiment of the invention; and

FIG. 7 is a flow chart for an exemplary embodiment without time control of progression.

### DETAILED DESCRIPTION

The present invention relates to media players capable of playing audio tracks. In the present disclosure the term audio tracks will be used to refer to data files and data streams containing audio data. The term audio data is not intended to preclude the inclusion of additional data. As such, an audio track may be any audio file or audio stream which also includes, for example, metadata which provides information about the audio track. An audio track may also be a multimedia file or data stream which includes other types of media information in addition to encoded music, for example video, animation, control signals for media systems etc. The invention particularly relates to transitions between audio tracks, wherein a first audio track is initially playing and a second audio track takes over. The transition from one track to the other may involve sound effects such as crossfading, filter effects and pre-recorded audio samples. A transition may be defined in a transition definition which may be in the form of a script. The transition definition associates the various sound effects with positions in the transition using position marks, and the current position in an ongoing transition can be controlled directly by a user, or it may be controlled by progression of time by association of the positions in the transition with time or with number of music beats into the transition. In embodiments where progression is controlled by progression of time or number of beats a user of the media player device may nevertheless control the progression of the transition by way of a user interface element and thus override the predefined progression. Various embodiments of the invention may allow transitions to be initiated, for example, by user interaction, by specifications in a transition definition, by external metadata files, or by music analysis of the currently playing audio track, or by a combination of these.

In the following description, the invention will be explained by way of examples and with reference to the attached drawings. The exemplary methods, apparatus, systems, and articles of manufacture may include, among other components, firmware and/or software executed on hardware. It should, however, be noted that the embodiments described are intended to be illustrative and they should not be considered as limiting. For example, it is contemplated that any or all of these hardware, firmware, and/or software components could be embodied exclusively in hardware, exclusively in firmware, exclusively in software, or in any combination of hardware, firmware, and software, except, of course, that certain components by necessity must have a physical implementation in order to interact with other physical objects, and in order to carry the information embodied in the software or firmware. Accordingly, while the following describes example methods, apparatus, systems, and articles of manufacture, the examples provided are not the only ways to implement such methods, apparatus, systems, and articles of manufacture. In particular, certain features and aspects that are described in combination herein do not all have to be present in all embodiments of the invention except to the extent they interact in order to provide specific functionality. For the sake of brevity and efficiency of disclosure of the invention, however, no attempt is made to describe every permutation and combination of subsets of features in distinct exemplary embodiments. Those with skill in the art will understand how various features may be combined dependent on the set of features and capabilities a particular embodiment should provide.

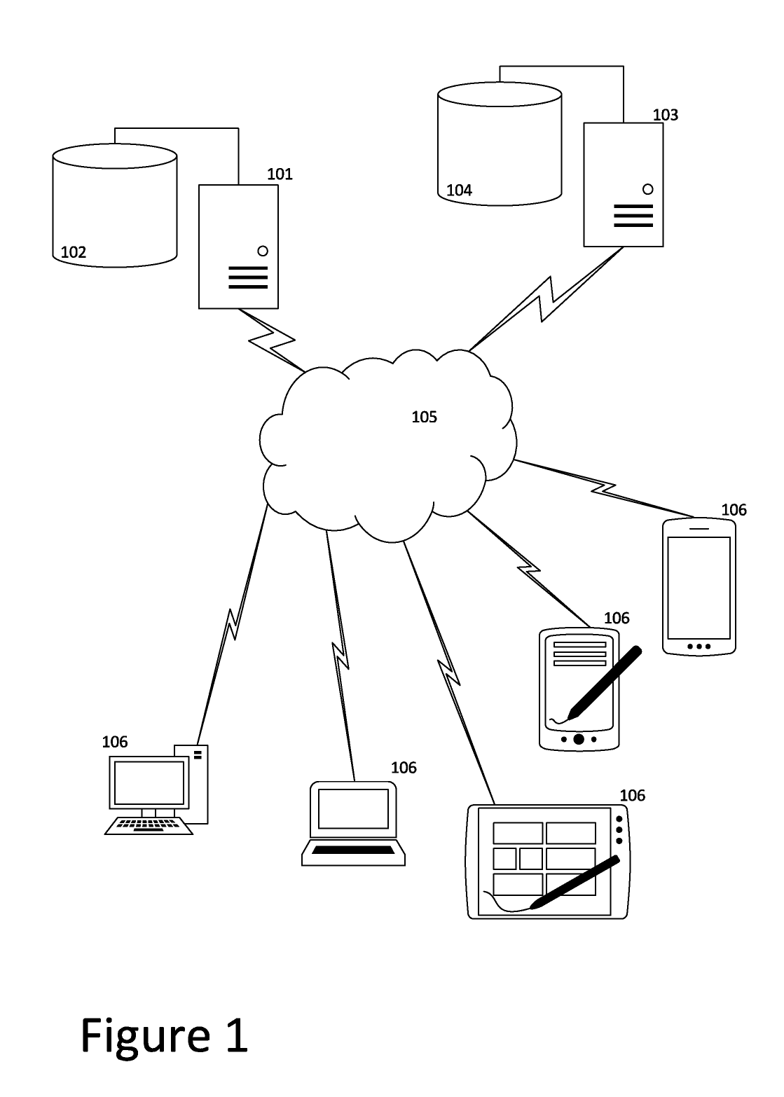

Reference is first made to FIG. 1, which shows a networked system of servers and devices that may be used to implement various aspects of the invention. This system represents an environment, or a context, in which the invention can be utilized. A first server 101 is connected to or incorporating a first database 102 which is a database containing media files including audio content. Such files, and any replication or streaming of data contained in such files, will be referred to as audio tracks in the present disclosure. Audio tracks is therefore intended to refer to any media content which includes audio and is capable of being processed and/or presented during utilization of the present invention. The first server 101 will be referred to as media server 101 in the present disclosure.

A second server 103 is connected to or incorporating a second database 104, which is a database of social media related data, such as user accounts and user created content. The second server 103 will be referred to as social network server 103 in the present disclosure.

The two servers may, of course, be implemented in only one actual computer, or one or both of the servers may be distributed over several computers which share workloads and/or represent redundancy intended to reduce the likelihood of down time for the system as a whole. When the present disclosure refers to an example including two distinct servers, this should not be interpreted as a limitation, and any configuration of one or more servers located in one or more geographical locations is consistent with the principles of the invention. The same is the case with the logical presentation of the services provided by the servers. As such, they may appear as one service providing media content as well as social interaction, or one service may provide media content while another service may provide the social network.

It should be noted that in some embodiments of the invention, the social network does not have to be more than a file sharing service. Furthermore, certain embodiments of the invention do not rely on interaction with servers at all and include only aspects that are embodied exclusively on a local device, or on several local devices that interact using a peer-to-peer protocol.

The local devices 106 may be any type of device capable of storing or receiving media content and process and present that media content. Such devices are illustrated in FIG. 1 as a smartphone, a PDA, a tablet computer, a laptop computer and a desktop computer, or PC. The local devices are referred to using the same reference numeral, since there is no need to distinguish one from another. The servers 101, 103 as well as the local devices 106 are connected to a computer network 105 which may be the Internet, a corporate network, a local network, or any combination of networks, including cellular networks.

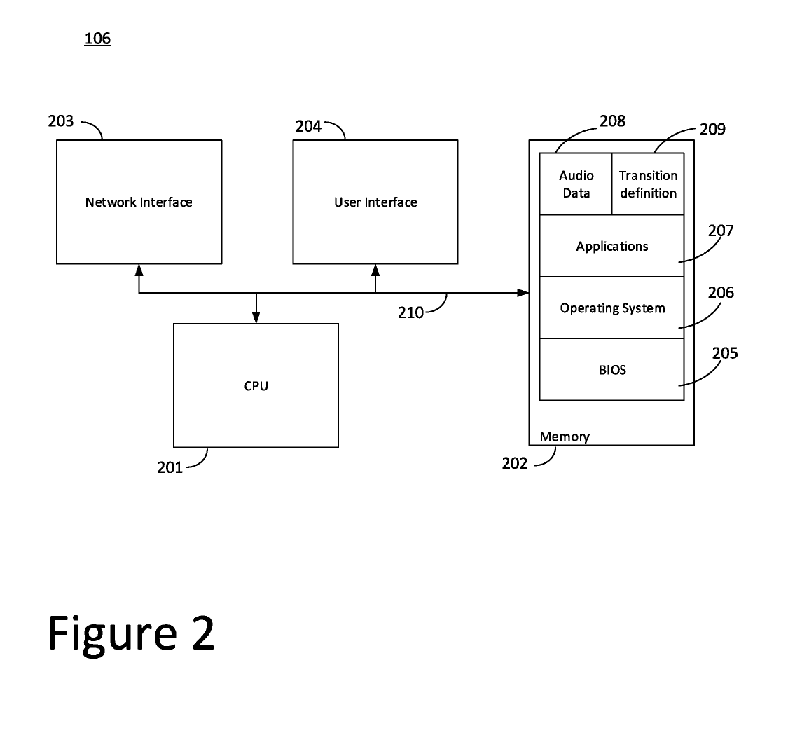

Reference is now made to FIG. 2 which illustrates an exemplary implementation of some of the modules of a client device. The client device according to this example includes a CPU 201, memory 202, network interface 203, and user interface 204. These modules, which all may include more than one components, are capable of communicating with each other using one or more communication buses 210. For reasons of simplicity, the memory module is shown as one module, but those with skill in the art will understand that this module may include several types of memory, including long term persistent memory such as hard drives, flash drives and ROM, as well as short term working memory such as RAM. Additional hardware may be present in various embodiments of the invention.

The memory 202 may include the BIOS 205, the operating system 206, applications 207, audio data 208 and transition definitions, for example in the form of script files 209, which will be explained in further detail below. Applications 207 may include full blown applications as well as smaller apps, and also virtual machines and computer programs running inside such virtual machines, and the memory 202 may, of course, also store other types of data in addition to audio data 208 and transition definitions 209.

Also, the various hardware modules may incorporate software or firmware components such as drivers, but this is well known in the art and no attempt will be made to describe this aspect further.

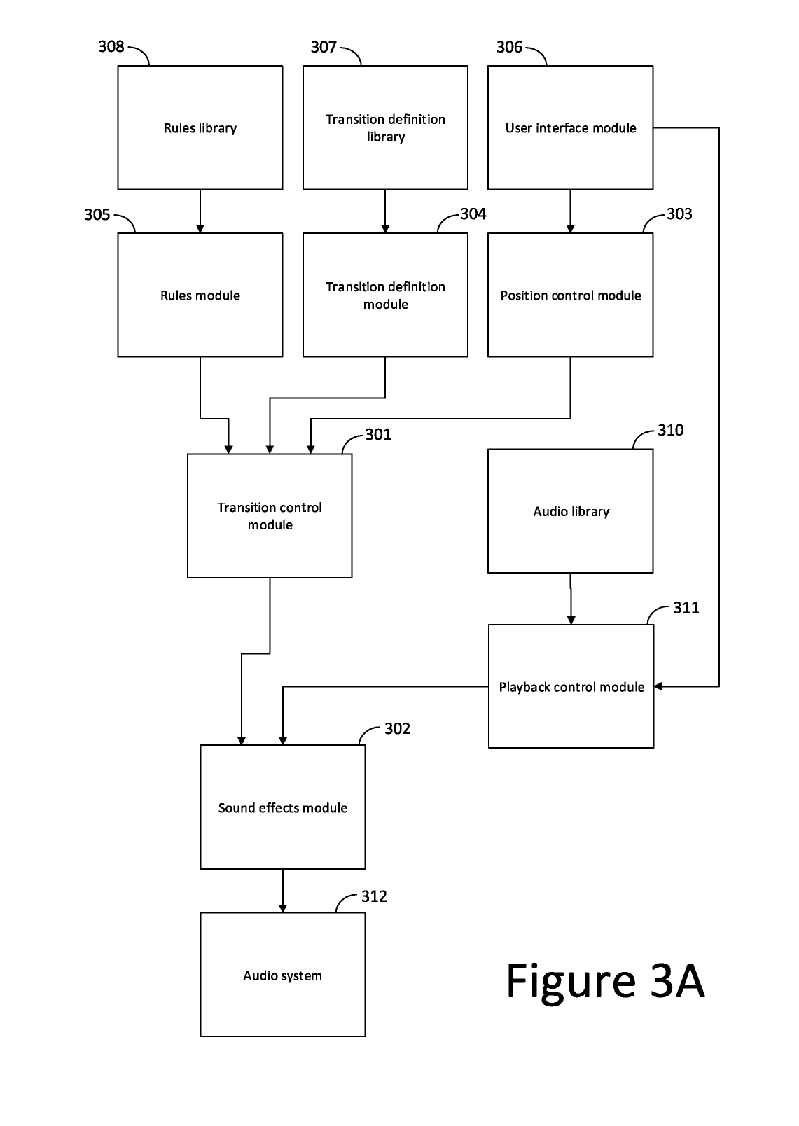

FIG. 3A illustrates in further detail how an embodiment of the invention can be structured in terms of interacting modules. The modules may be implemented as software applications 207 or parts of software applications, but some functionality of a module may also be implemented in the operating system 206, in BIOS 205, or even as hardware components.

The overall functionality of the embodiment illustrated in FIG. 3A includes the ability to access and play audio tracks that are available from an audio library, and to implement transitions from one audio track to the next, for example in accordance with a sequence defined in a playlist. A transition may include sound effects, which will be referred to as filters and audio samples, respectively. When and how a sound effect is applied during the transition is controlled by a transition definition, and a user will be able to interact with the transition using user input devices, for example in the form of graphical elements on a display.

The embodiment illustrated in FIG. 3A includes a transition control module 301 which controls a sound effects module 302 to apply sound effects during the transition from one audio track to another. The effects module may, of course, be capable of applying sound effects also during regular playback of a single audio track. The transition control module 301 delivers control input to the sound effects module 302 based on input from a position control module 303, and/or from a transition definition module 304. Additional input may be received from a rules module 305. The position control module 303 will control the progression of the transition in accordance with user input, normal time progression, or normal time progression modified by user input. User input may be received from a user interface module 306. According to some embodiments the transition definition module 304 may be an integrated part of the transition control module 301, and it may already include a transition definition that is part of its code. In other embodiments the transition definition module 304 loads a particular transition definition from a transition definition library 307 which may be transition definition data 209 resident in memory 202, as illustrated in FIG. 2. The rules module 305 may include rules for how to interpret a transition definition. Such rules may be coded into the rules module 305, or they may be received from a rules library 308. The rules module 305 may be an integrated part of the transition control module 301 or a separate module, and the rules themselves may be coded into the rules module 305, for example as part of the source code/program code of an application implementing the invention. In embodiments where rules are retrieved from a rules library 308 external to the rules module 305, rules may be included as part of a transition definition and specific to that transition definition. Alternatively, rules may be user configurable but separate from the transition definition, such that a given transition definition will give different results depending on which rules are applied when it is interpreted.

The sound effects module 302 receives audio data from audio library 310 through a playback control module 311. The audio library may be a repository of locally stored audio data 208 present in memory 202, as illustrated in FIG. 2. Alternatively, or additionally, audio data may be received as a data stream delivered from a media server 101 over the network interface 203 of the device 106. Streamed data may, of course, be temporarily stored or buffered in local memory 202, as is well known in the art. Whether the audio library 310 is interpreted as a local repository, locally buffered data, or a remote repository, or as a combination of two or more of these options, is a matter of perspective. For the purposes of the present disclosure and the claims, the term audio library should therefore be interpreted as any combination of remotely or locally stored data accessible from a device 106.

The sound effects module 302 applies sound effects to the received audio data in accordance with effect control data received from the transition control module 301 and creates modified audio data as its output. The modified audio data may then be delivered from the sound effects module 302 to an audio system 312 to be rendered. For the purposes of the present disclosure the term render will signify the transformation of media data to information that can be perceived by humans. For audio that means creating sound from audio data. As such, the audio system may include functionality that is distributed between an application implementing the present invention, a media player external to the application implementing the present invention, additional hardware, software and firmware that may, for example, be controlled by the device operating system, as well as software and hardware external to the device itself, such as amplifiers, loudspeakers etc. To the extent that an embodiment is capable of controlling additional types of effects, for example light effects or video effects, rendering refers also to the transformation of data to light or video, and the audio system may be replaced by a multimedia system which may include the necessary functionality to be able to control a light system or a video display.

The user interface module 306 generates the various user interface elements that will be displayed on a display which may be part of the physical user interface 204 of the device 106. The user interface module 306 is also capable of receiving user input, which may be delivered through a touch screen, a pointing device, e.g. a mouse, or by some other user input device known in the art, depending on the capabilities of the specific device 106. Some of these user interface elements will be described in further detail below. User input relating to position (e.g. points in time in a transition) will be forwarded to the position control module 303, while other user input may be sent directly to the playback control module 311. Examples of the latter may include addition or removal of specific audio tracks from a playlist, adjustment of volume controls, playback start, stop and pause, and immediate playback or application of specific sound effects that are not part of a transition definition.

The position control module 303 controls the progress of the transition, for example by outputting a normalized value representing a position within the transition. By way of example, this normalized value may be a value between 0 and 1, with 0 representing the beginning of the transition and 1 representing the end of the transition. Alternatives are, of course, possible, for example a percentage or any other well defined range of numbers. In the description provided below it will be assumed that the normalized value progresses from 0 to 1, but it should be kept in mind that this is an arbitrary choice which should not be interpreted as limiting on the invention. In embodiments where the length of a transition is or may be defined, for example in seconds or beats of music, the position control module 303 may be configured to output a gradually increasing normalized position control value based on a clock or a timer. In order to count from 0 to 1 (with a suitable resolution in terms of number of decimal points and number of updates per second) in a time period defined as the length of the transition, the length of the transition can be provided by the transition control module 301 to the position control module 303 prior to the initiation of the transition. The definition of the length of the transition may, in various embodiments, be defined in the transition definition itself, or for example as a user configurable option in the application. By multiplying the normalized value with the received value for the length of the transition, the position control module 303 may alternatively output a value which can be directly compared to time stamp values in the transition definition.

During normal progression of time controlled transitions, i.e. without interference or interruption by user input, the normalized value will increase in accordance with a clock or counter that is part of the position control module 303 or which the position control module 303 can derive for example from a system clock in the device 106. Thus, during an uninterrupted transition the transition will progress according to normal time progression, and instructions received as part of a transition definition, for example a script received from the transition definition module 304 will be executed in accordance with position marks in the form of time stamps associated with each instruction. In embodiments where the transition control module 301 receives the normalized value from the position control module 303, the transition control module 301 derives the current temporal position in the transition by multiplying the normalized value received from the position control module 303 with the length of the transition as defined by the transition definition, and compares this value with the time stamps in the script. In embodiments where the position control module 303 has already performed this conversion, the received value can, of course, be compared directly with the time stamps. Yet another option is to use normalized values instead of time stamps in the transition definition and a separate definition of transition length.

This progression, as defined by the time stamps in the received transition definition may, however, be overridden by user input received from the user interface module 306, as will be described below. The length of the transition may be defined explicitly in the transition definition. In other embodiments the length of the transition may be derived from the highest valued time stamp in the transition definition (or, alternatively, to the point in time where the filters and sound effects defined in the transition definition ceases to have an impact on the audio output, e.g. at the end of an audio sample).

The progression of a transition defined in a transition definition may, for example, include a number of entries defining events during the transition. Each such entry is associated with a position in the transition. In time controlled transitions the transition definition may include a time stamp defining the event's temporal position in the transition, for example based on time or number of beats. In transitions that must be controlled manually by user input they may be associated with a position mark representing a normalized value ranging, for example, for 0 to 1, where 0 represents the beginning of the transition and 1 represents the end of the transition. When the transition progresses uninterrupted, the various entries take effect at the various points in time defined by the transition definition. When a user overrides normal progression, however, or for transitions that must be controlled manually, the normalized position control value representing the relative position in the transition will no longer be determined by a clock or counter, but by the position of a user control element on the display. If the transition definition is not associated with time, the positional value generated by the position control module 303 will be related directly to corresponding position marks in the transition definition.

Consequently, as the user manipulates a user interface element in order to move backwards or forwards in the transition a corresponding positional value is generated and the position in the transition is changed accordingly. This means that the transition may move forward at a higher or lower speed than what would otherwise be the case, and also that the transition may move backwards or be frozen. If and when the user ceases to manipulate the progression of the transition, normal progression will again commence from the point in time corresponding with the current position in the transition. For transition definitions that are not associated with time control, or in embodiments of the invention where this feature is not included, the transition will remain frozen in the current position if the user ceases to manipulate the progression, and sound effects defined in the transition definition will continue to be applied in accordance with rules applicable to a situation where progression is frozen.

The transition control module 301 receives appropriate transition definitions, rules and position control data, and based on this information, effect control data is sent to the sound effects module 302. If, according to the transition definition, a given sound effect should be applied at the current position as determined based on the current positional value received from the position control module 303, instructions to apply that effect is sent to the sound effects module 302. It is in accordance with the invention, however, to send certain commands to other modules. For example, in some embodiments, playback start and playback stop commands could, for example, be sent to the playback control module 311 or directly to audio system 312. Also, certain commands could be sent from the playback control module 311 to the audio system 311 directly and not by way of the sound effects module. In order to avoid unnecessary clutter of the drawings, no attempt has been made to illustrate these alternatives.

The interpretation or application of the instructions in the transition definition may be modified based on rules received from the rules module 305, on how the position information received from the position control module 303 is currently progressing (e.g. its speed and/or direction). Other internal conditions in the transition control module 301 may also be taken into consideration.

The direction or speed of the position changes may be calculated by the transition control module 301 based on a record of previous positions. Alternatively, this information can be calculated in the position control module 303 and forwarded to the transition control module 301.

The sound effects module 302 may be a separate module, or it may be part of an audio engine module which controls digital signal processing in the application. The audio engine may also be part of the audio system 312. The sound effects module 302 may include a number of sound effects which may be implemented as digital filters or transfer functions executed as digital signal processing of the audio data received from the audio library 310. In addition the sound effects module 302 may have access to additional, pre-recorded sound effects (sounds like sirens, whistles, explosions, crashes, gunfire, horns etc.) which may be stored in memory 202 as sound files or coded into the sound effects module 302 directly. When these pre-recorded sound effects are invoked, either by a script or by user input, they are mixed into the audio playback signal by the sound effects module 302. It is in accordance with embodiments of the invention to download additional sound effects, both in the form of new filter definitions and new pre-recorded audio clips, for example from a repository in one of the servers 101, 103.

FIG. 3B shows some of the modules of FIG. 3A and an example of how data may flow between them in connection with a transition in some embodiments implementing time controlled transitions. The transition control module 301 receives rules 321 from the rules module 305, as well as a transition definition 322 from the transition definition module 304. The receipt of rules and a transition definition does not have to happen in any particular order, and may happen immediately before the transition is initiated or at any time prior to that. The transition control module 301 determines the length of the transition from the transition definition or from a configuration parameter or user input, as described above, and provides this information 323 to the position control module 303. When the transition is initiated, the position control module 303 starts an internal clock or counter in order to produce a normalized positional value as described above. This value is provided 324 to the transition control module continuously during the progression of the transition. Alternatively, in some embodiments the position control module 303 converts the positional value to a time value representing the time relative to the beginning of the transition. If the user manipulates the progression of the transition, the positional value is instead derived from the user manipulation, as described above and in further detail below.

Based on the received rules 321, the definition of sound effects in the received transition definition 322, the current positional value 324 and possibly also one or more previous positional values, the transition control module calculates appropriate parameters and transfers effect control data 325 to the sound effects module 302. The effect control data 325 includes invocation of sound effects defined in the transition definition and parameters calculated by the transition control module 301. The sound effects module receives two input streams 326, 327 representing Track A and Track B, respectively. These input streams are processed by the sound effects module 302 in accordance with the effect control data 325 received from the transition control module 301, and they are mixed together along with any additional audio samples referenced by the received effect control data 325. The processed audio stream is delivered as output 328 and may be forwarded to the sound system.

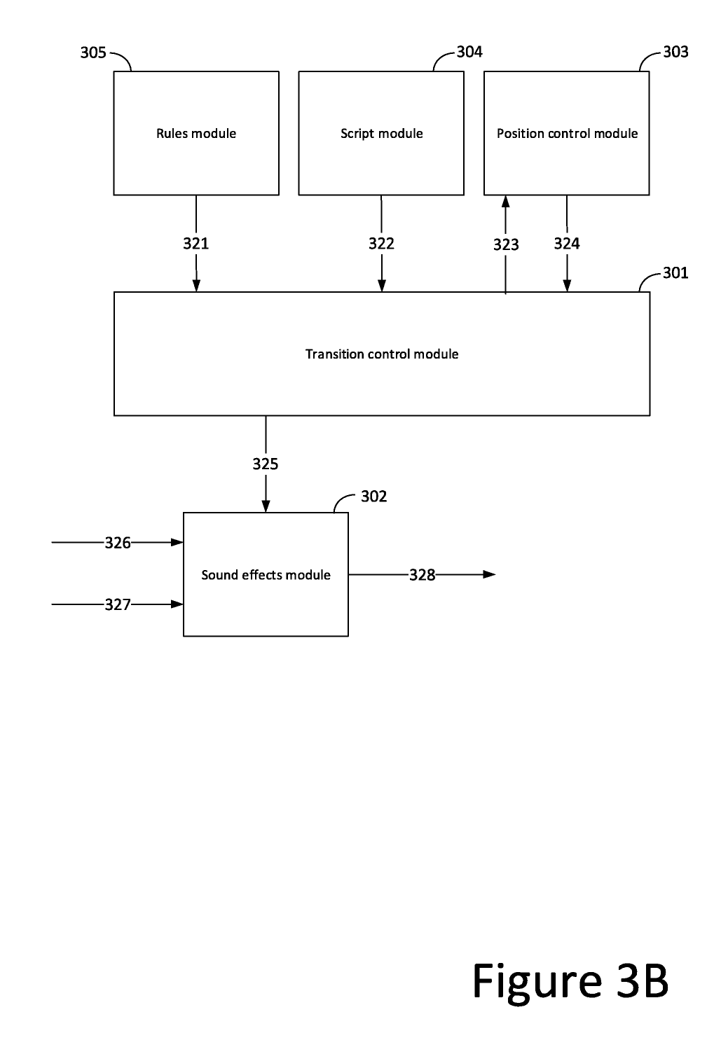

The user interface module 306 will now be described in further detail with reference to FIG. 4, which shows an example of a user interface window 400 generated by the user interface module 306 and displayed on a display which is part of the user interface 204 of a device 106.

The user interface module 306 is configured to generate a number of user interface elements. Some of these elements are purely informational for the user, while others are controls associated with functionality which may be invoked by user input. The example shown the FIG. 4 is consistent with a smartphone device with a touchscreen, but the principles apply for other types of devices using other types of user input, for example pointing devices like a mouse or a stylus.

A first user interface element is a playback symbol 401. The playback symbol may be invoked by a user to initiate playback of an audio track in a manner well known in the art. Similarly, the playback may be paused by the user by invoking a similar pause symbol 402. Additional user interface elements representing user invokable functionality like stop, fast forward, rewind and skip may also be included, but are not shown in the drawing in order not to clutter the view unnecessarily. Their functionality is well known in the art, and it is also well known to make these user interface elements dynamic, for example by showing the play symbol 401 and hiding the pause 402 and/or stop symbols while no track is being played, and conversely hiding the play symbol, but showing the pause and/or stop symbols during playback.

A volume control symbol 403 may be associated with functionality for adjusting the volume, and possibly also additional playback control functions such as tone controls or equalizer, balance between stereo channels etc. Additional user interface elements representing these functions may be displayed subsequent to user invocation of the function associated with the volume control symbol 403, but they may, of course, also be displayed permanently on the display, particularly on devices with larger screens. However, their functionality and operation are well known in the art and will not be discussed further in this disclosure.

In this exemplary embodiment of a user interface window 400, three symbols 404 represent additional sound effects that may be invoked by the user. As described above, these effects may represent filters or transfer functions creating effects like echo, reverb, phasing, etc., as well as pre-recorded sounds, or audio samples. When they are invoked by a user, the user interface module 306 may send corresponding control signals to the playback control module 311. The playback control module may then fetch any required pre-recorded effect from memory 202 and instruct the sound effects module 302 to mix the pre-recorded effect into the audio track currently being played and/or process the audio track data with the required filter to create the effect, all according to the input received from the user.

A further user interface element is a transition control element 405, which may also be referred to as a slider user interface element, a transition slider element, a transition progression control, or a transition marker. The transition control element 405 will during normal playback be positioned to the far left of its available positions, it may be hidden, or it may be displayed as a control element for initiating a transition. (Alternatively, a separate user interface element or a menu entry may serve this purpose.) When a transition from one track to another commences the transition control element 405 will move or be moved from left to right and its position will be representative of the progress of the transition. In other words, the far left position may, for example, be representative of the positional value 0 and the far right position may be representative of the positional value 1, provided that the progression of the transition is represented as values between 0 and 1. Positions between the far left and the far right are representative of values between 0 and 1. As mentioned above, other alternatives are possible for numerical representation of the progression.

The transition control element 405 is a user invokable user interface element, which means that the user may move the transition control element 405 forward or backward, or hold it still. Whenever the user manipulates the transition control element 405, the user interface module 306 will report the position of the transition control element 405 to the position control module 303, which in turn will output the corresponding normalized value representative of the position in the transition, as described above. This value will be delivered to the transition control module 301 and thus the normal progression of the transition can be overridden. When the user does not manipulate the transition control element 405 the situation is reversed, and the position of the transition control element 405 is controlled by the progression of the transition as reported from the position control module 303 to the user interface module 306. Of course, for transition definitions without time control, or embodiments of the invention that do not implement time control of transitions, this user generated value will always control the transition.

The transition control element 405 may, as will be apparent to those with skill in the art, be implemented in a number of different ways. As such it is not necessary for the available positions to go all the way from the left edge of the user interface window 400 to the right edge. Instead, the transition control element may only move a predefined limited distance from left to right, or indeed even from right to left, top to bottom, bottom to top, or in any other manner, for example in a circle.

In order to provide the user with additional information, the transition control element 405 may be supplemented with a graphic user interface element 406 consisting of two parts 406a, 406b. During normal playback this user interface element is dominated by the first part 406a, which displays a graphic representation of the currently playing track, Track A. When a transaction from Track A to Track B commences, a part 406b of the graphic user interface element 406 starts to display a graphic representation of Track B instead. During the progression of the transition, the part 406a representing Track A becomes gradually smaller, while the part 406b representing Track B gradually becomes bigger. When the transition is complete, the part 406b dominates the graphic user interface element 406, and it becomes the first part 406a for purposes of the next transition. If the transition control element 405 moves in a circle instead of from left to right or top to bottom, the user interface element 406 may instead be circular and the two parts 406a, 406b may be sectors of that circle, much like a pie chart. Of course, a number of other arrangements of the user interface elements are possible. It is, for example, not necessary for the transition control element 405 and the visual element 406 to be visually associated.

The combination of the transition control element 405, the transition definition and the rules enables a user to control several parameters related to several sound effects using only one control element, and the rules may be defined such that what the parameters and sound effects control and how depend on how the user moves the transition control element 405. A separate menu 407 may be available in a separate area of the display or as a pop up window which can be opened by the user. This menu may provide access to a list of transition definitions available in the transition definition library 307. User selection of a particular transition definition from this menu 407 will cause that particular transition definition to be loaded by the transition definition module 304 and provided to the transition control module 301.

Similar functionality to that which is described above can be realized also if the user interface 204 is not a touch screen and the user uses a pointing device like a mouse instead of a finger.

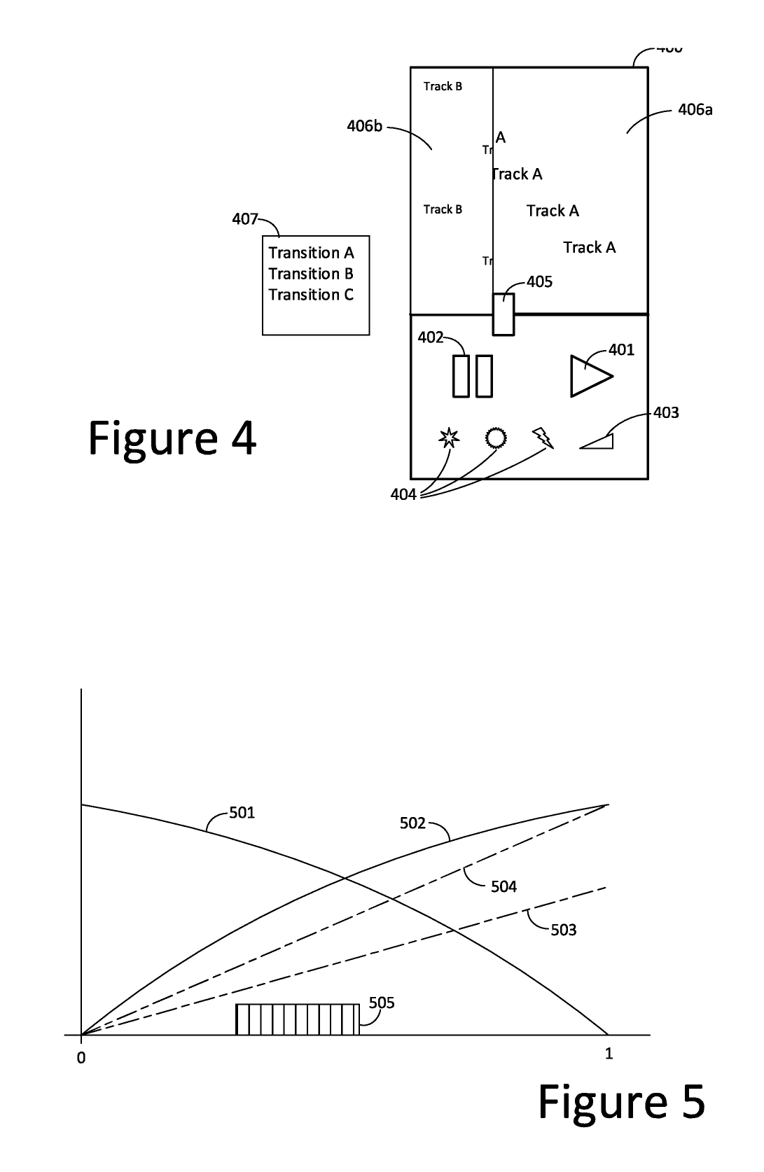

Turning now to FIG. 5, the progression of an exemplary transition is illustrated therein. The progression of the transition runs along the horizontal axis, from a starting point at value 0 to the completion of the transition at positional value 1. In transitions that are time controlled, the horizontal axis represents progress of time a progress that may be modified by user input while in transitions that are not time controlled and embodiments of the invention that do not implement time control, the horizontal axis simply represents a user controlled positional value. The vertical axis is representative of parameter value, for example volume, the extent to which a given effect, or filter, is applied, etc. It must be understood that the parameter values illustrated in this diagram are not the values that are delivered from the transition definition, but values that are delivered as input to the filters. In other words, this is how the parameter values provided by the transition definition change during progression of the transition, in accordance with applicable rules.

A first curve 501 represents the volume of Track A, and a second curve represents the volume of Track B. These two curves alone represent traditional crossfading, where a first track fades out while a second track is faded in (i.e. increases in volume). According to the present invention, additional parameters are controlled during the transition, here exemplified, inter alia, by line 503 which may, for example, represent an echo effect which is applied to Track A while it is being faded out. The echo effect may, as mentioned above, be implemented as a digital filter in the sound effects module 302. The resulting effect on the transition as a whole will be that while Track A is fading out, it will at the same time start to echo more and more until it fades out entirely.

Similarly, curve 504 may represent the cutoff frequency of a low-pass filter applied to Track B. In this case the vertical axis represents the cutoff frequency, which moves upwards as the transition progresses. The result will be that at the beginning of the transition the bass of Track B will fade in more rapidly, such that the beat of Track B will be more audible initially, while vocals and additional instruments will become audible only after Track A has substantially faded out.

In addition to the application of filters and adjustment of their parameters, a transition may also include playback of a sound file or an audio sample, illustrated as a rectangle 505 indicating a certain volume and duration. Playback commences at a predefined position in the transition, or when user input identifying the particular sound file is received.

A transition is executed as a way of finishing playback of a first track and commencing playback of a second track. This can happen in different ways. A first possibility is simply that the first track comes to an end and the second track is the next track listed in a playlist (or selected randomly from a playlist or a library). Another possibility is that a user initiates the transition by forcing playback to jump to the next audio track in a playlist, or by selecting any audio track from a library of tracks to be the next audio track. It is also possible to create transition definitions that not only define filters and audio samples (sound effects), but also identify upcoming tracks. Other possibilities may also be contemplated, but in all cases a first track and a second track is treated in a specific manner during the progression of the transition.

A special case may be implemented in some embodiments of the invention, namely that the same track is used as both Track A and Track B. In this case the two tracks may be synchronized meaning simply that the same stream of audio data is delivered as both audio streams 326, 327. The transition will then be a transition between different sound effects applied to the same audio track. Some embodiments of the invention may even implement only this special case, thus providing an application that is not capable of crossfading between two different tracks, but only of executing a transition from playback of a first audio track to playback of a second audio track where the first and the second audio tracks are instances of the same stream of audio data, but the sound effects that are applied to them differ and depend on position in the transition.

Furthermore, a transition may be initiated by a user or it may be initiated at a predefined point in time, for example at a specific number of seconds into Track A. Also, a given transition may be used for any two tracks, or it may be designed as a transition between two specific tracks, for example as defined in the transition definition. Various embodiments of the invention may implement all or just some of these alternatives.

A transition definition may be defined in a script using a specific script language. The script defining the transition may then be interpreted in a process translating the script to the same binary format before it is executed in the application.

Examples of commands or effects that may be available in an embodiment of the invention include
gain—which specifies the volume of the playback of a track
EQ—which specifies a particular filter (for example a low pass, high pass or band pass filter)
reverb—which adds reverberation to the playback of a track
sample—which initiates playback of an audio sample (a prerecorded sound effect)
playback—which starts or stops playback of a particular track.

An example is the following effect control data
a paramEQ mode:lopass2nd wet:1 hz:20000 q:0
   which would specify that Track A should be processed by a 2^{nd} order low-pass filter with a cutoff frequency of 20,000 Hz and a Q factor of 0.

Similarly, the effect control data
a playback stop
   simply causes playback of Track A to stop.

When a sound effect has been called once and does not receive additional effect control data, the particular sound effect will continue to operate on the audio data that constitutes Track A and Track B with the parameters already specified, except if the sound effect has a specific duration, such as playback of an audio sample with a predetermined duration (for example a “bang”). Some audio samples may, of course, continue until they are stopped by new effect control data (for example a “siren”).

In general, effect control data have the same effect whether they represent sound effects invoked by a transition definition such as a script, or sound effects invoked by user interaction. However, in some embodiments of the invention there may be certain differences. One difference is that while user interaction happens in real time and it is impossible to know what a user will do next until user input is actually received, a script defines the progress of the transition in its entirety, and all calls to different sound effects or other sound playback or processing during the transition is therefore known in advance. Consequently, it is possible to define the progression from one set of parameters for a specific filter received at a first position in the transition (e.g. a first point in time) to a second set of parameters for that same filter received at a second position (e.g. a second point in time). That progression may be defined as an interpolation of intermediate parameters according to some rule. Rules of interpolation may, of course, be applicable for user generated positional values, but not for direct user invocation of sound effects independently of the transition definition.

The progression of a transition can be explained by way of an example, based on the following script. It should be noted that while this example and the following explanation of rules are based on an embodiment where the transition definition is in the form of a script and the transition progresses according to time when not manipulated by a user, the same principles apply to transition definitions in other formats, e.g. binary, and for transitions that do not progress according to time. For the latter case, time stamps may be replaced by normalized values and progress in time should be thought of as progress in position.

| | | |
|---|---|---|
| 0.01 | a | gain db:0 |
| 0.01 | b | playback start |
| 0.01 | b | gain db:−100 |
| 0.01 | a | paramEQ mode:lopass2nd wet:1 hz:20000 q:0 |
| 11.9 | a | paramEQ mode:lopass2nd wet:1 hz:20 q:0 |
| 12.5 | a | gain db:−100 |
| 13.0 | a | playback stop |
| 13.0 | b | gain db:0 |
| 0.7 | s | sampler play:LopassTransitionsweep1 |
| 6.5 | s | sampler play:LopassTransitionsweep2 |

In the example listed above a first track, Track A, is playing when the script is called. By definition the script starts at time t=0.00 s. A hundredth of a second into the script the gain of Track A is set to 0 dB which means the audio data passes through the filter without attenuation. At the same time, as specified by the next two lines in the script, playback of Track B is started, but its volume is attenuated with 100 dB. The following line, which is also applied at 0.01 s into the transition, a 2^{nd} order low-pass filter is applied to Track A. This line contains the effect control data described above: a cutoff frequency of 20,000 Hz, 0-factor 0, and wet set at 1, which means that Track A is passed through the filter in its entirety. (Conversely, if wet is 0 also known as “dry” the signal bypasses the filter entirely. A wet value between 0 and 1 means that the result should be a mix between a dry (unprocessed) and a wet (processed) version of the track.)

The following line again specifies application of the 2^{nd} order low-pass filter, but this time 11.9 seconds into the transition and the cutoff frequency is now at 20 Hz. In accordance with the invention this repeated application of the same effect or filter may invoke a rule specifying how the effect should be applied between two references to the same filter. Of course, certain filters may be associated with a default rule which by definition sets a second parameter value a given amount of time after the filter is invoked and also defines an interpolation function. In this way a filter may be given a finite duration and a progression even if it is invoked only once.

Rules will be explained in further detail below, but in this example a possible rule could be simple linear interpolation between the two references to the low-pass filter. In other words, the filter will continuously receive an updated parameter value for the cutoff frequency from the first time the filter is called to the second time it is called such that at the point in time specified the second time the filter is called, at 11.9 seconds, the cutoff frequency will have reached 20 Hz.

12.5 seconds into the transition the gain of Track A should reach −100 dB, which again means that a rule will determine how gain is adjusted between t=0.01 s and t=12.5 s. Again the rule may be linear interpolation, ensuring that Track A is gradually faded out during the transition. Similarly, at 13.0 seconds playback of Track A stops, while the gain of Track B reaches 0 dB, which means that it from this point forward will pass through the sound effects module 302 without being attenuated. It should be noted that the script only provides parameter values for a limited set of points in time during the transition, for example two parameter values. The transition control module 301 calculates the remaining values based on the parameter values provided in the script, the temporal position in the transition provided by the position control module 303, and any applicable rules.

The transition is completed after 13.0 seconds. However, the script also specifies that two audio samples, or prerecorded sound effects, should be played back during the transition. Playback of the first audio sample should commence 0.7 seconds into the transition, while playback of the second audio sample should start 6.5 seconds into the transition. The two audio samples may be sound files or some other accessible portion of audio data referred to as LopassTransitionsweep1 and LopassTransitionsweep2, respectively.

Rules may, in different embodiments of the invention, be implemented in different ways. In some embodiments rules may simply be hard coded into the sound effects module 302 or some other part of the application, and specify how a given filter should be applied in different circumstances. In particular, a rule for a given filter may specify how parameter values should be implemented between repeated calls to the same filter. Some filters may take more than one parameter, and if two or more parameter changes between repeated calls, the same or different rules for interpolation may apply to the different parameters.

Typically, a rule may be a function which takes the relative progression of time between a first and a second invocation of a filter as an input variable. It may also take the first and second parameter value as input, and as output it may produce a gradual transition from the first parameter value to the second parameter value. Simple linear interpolation has already been mentioned. Other alternatives include, but are not limited to, logarithmic, exponential and s-curve, which are all well known in the art. Another simple alternative is, of course, to maintain the first parameter value constant until the filter is called the second time, and then change it in one immediate step. A non-exhaustive summary of possible rules for how parameter values should be determined for points in time where the parameter value is not specified in the script can be as follows
no value—the filter or effect does not receive any parameter value
closest past value—the filter or effect receives the closest previous value
closest value—the filter or effect receives the closest specified value, whether it is specified in the future or in the past
closest future value—the filter or effect receives the closest value specified in the future (i.e. specified at a point in time not yet reached by the transition)
last specified value—the filter or effect continues to receive the last value it received
interpolation—the filter or effect receives an interpolated value as determined by a past parameter value and a future parameter value as defined in two invocations of the same filter and a defined function.
   It should be noted that while some of these options may seem redundant they are not, when taken into consideration that a transition may be controlled by a user to run backwards or stand still.

Rules may therefore apply differently depending on whether the transition is progressing forward or backward, progressing at a higher or lower speed than normal, or being held in one place (“frozen time”). Temporal progression may easily be determined based on the current and previous temporal values calculated from the received positional values, and the points in time at which they were received.

With respect to audio samples a rule may determine whether the audio sample should be played when the transition progresses forward, when the progression progresses backward, and when the transition is frozen at one point in time. Some options that are consistent with embodiments of the invention include
forward—the audio sample should be played normally when the transition progresses forward
backward normal—the audio sample should be played normally when the transition progresses backward
backward reversed—the audio sample should be played reversed (backwards) when the transition progresses backward
loop—a segment of the audio sample should play continuously
loop when frozen—a segment of the audio sample should play continuously if the user freezes progression of the transition
   Additional options may, for example, define whether the audio sample should always be played at its predetermined tempo or speed up/slow down if the tempo of the transition is changed by the user.

As already mentioned, rules may be hard coded into some part of the application. In other embodiments the rules may be defined as part of the script, in a separate library that may be changed or added to, for example as plug-ins, or as a combination of the above. For example, the hard coded rules may specify that parameters for a given filter or effect should be interpolated between repeated calls, but the script may override or define exactly which function that should be used for the interpolation. In principle there are no limitations to how much a script or an external library should be capable of controlling, and as such a user may also be able to customize a transition definition by changing the library of rules used by the application when executing a transition.

Reference is again made to FIG. 4 showing an example of a user interface in accordance with an embodiment of the invention. As mentioned above, the user interface includes a transition control element 405 which serves to indicate the progression of a transition. The transition control element 405 also allows the user to interfere with the progression of the transition. As such, a user may simply place his finger on top of the transition control element 405 and drag it forward or backward, or hold it still. The positions of the transition control element 405 on the user interface may, for example, be represented by coordinates. These coordinates may be converted by the user interface module 306 to a normalized value representing a position in the transition. Alternatively, the coordinates may be passed on from the user interface module 306 to the position control module 303 to be converted there. As mentioned above, the normalized values may be values between 0 to 1 where 0 is at a first end of the range of possible positions for the transition control element 405 and corresponds with the beginning of the transition, and 1 is at a second end and corresponds with the end of the transition. (Different graphical layouts and relative values are, as already mentioned, consistent with the principles of the invention.)

During user manipulation of the transition control element 405 certain rules may determine how the effects and filters are applied, as described above. Rules also apply to how the audio tracks are affected, but in most embodiments this will be determined once and for all. In some embodiments the audio tracks simply keep playing and it is only the application of the sound effects that are influenced. In embodiments where this is the case Track A will, of course, stop playing before it is actually stopped by the transition script if the track ends. Similarly, Track B will not commence playing until the script is allowed to progress far enough by the user manipulating the transition control element 405 for the script to initiate playback of Track B.

One rule that may typically be implemented in embodiments of the invention is a rule that determines when and how Track B should start playing if this is not defined in the script. A number of options are consistent with the invention, including at the end of the transition, at the beginning of the transition and according to a defined fade-in function, at the beginning of fade-out of Track A and with a fade-in function that mirrors the fade-out function for Track A, etc.

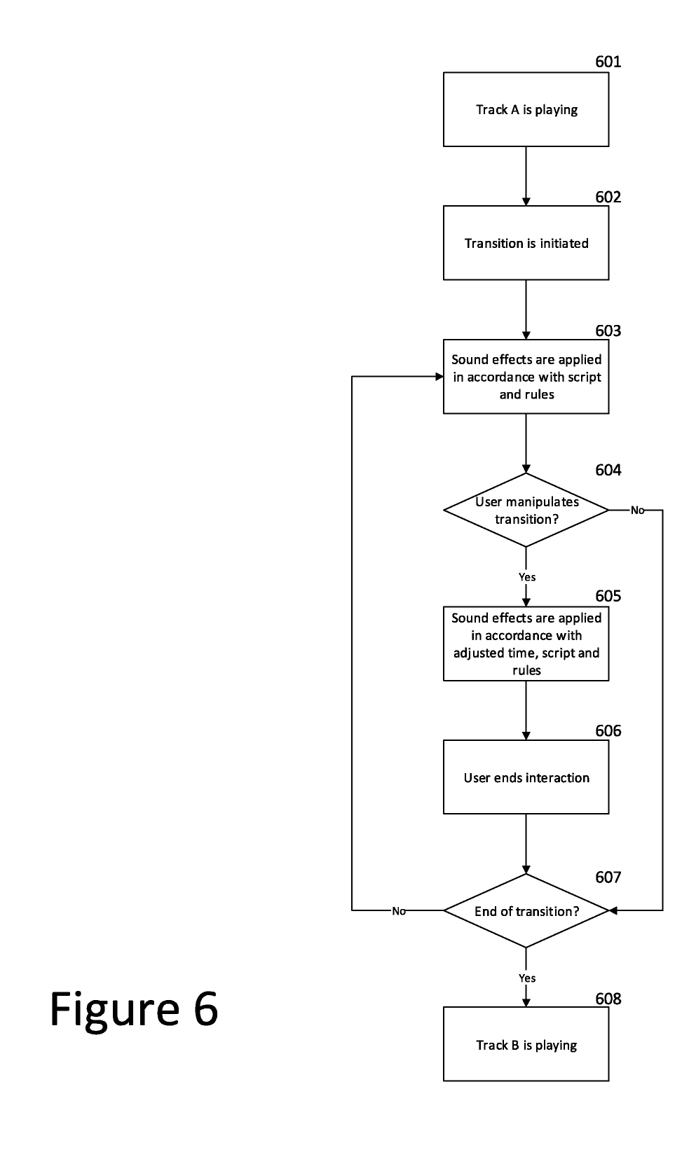

Reference is now made to FIG. 6, which is a flow chart illustrating how a transition may progress under the influence of user manipulation.

Prior to initiation of the transition, in step 601, Track A is playing. Then, in step 602, the transition is initiated. This may happen in a number of different ways, for example by user initiation, by an instruction included in the transition definition, or by metadata external to the transition definition and, for example associated with a playlist. Different embodiments of the invention may implement one or more of these as well as other possibilities.

After the transition has been initiated, the various sound effects, such as filters and audio samples, will be invoked at the right position in time, as indicated in step 603, and they will have the effect dictated by rules applicable to normal playback. In addition, user interaction that does not interfere with the progression of the transition may also be invoked here, such as playback of additional audio samples that can be invoked from the user interface. In the absence of any user interaction that actually manipulates the transition, as determined in step 604, the process will continue until it is determined in step 607 that the end of the transition has been reached. After the transition has ended, Track B keeps playing, as shown in step 608. Thus, a user may immediately end a transition by dragging the transition control element 405 all the way to the end. In some embodiments, dragging the transition control element all the way to the beginning will cancel the transition.

If it is determined in step 604 that the user has started manipulating the transition, as described above, the process moves on to step 605, in which sound effects defined in the transition definition are applied in accordance with time as adjusted by the user and rules that are applicable to the conditions the user has created. This continues until the user ends this interaction in step 606. After the user stops manipulating the transition by releasing the transition control element 405, it may be determined in step 607 that the transition has ended, in which case Track B continues playing, as shown in step 608. However, if the user ends manipulation of the transition without actually bringing the transition to its end, the process returns to step 603 and the transition definition dictates the progress of the transition until the user again starts manipulating its progression or until the transition ends. This ensures that the transition will actually complete whether or not the user is capable of completing it manually.

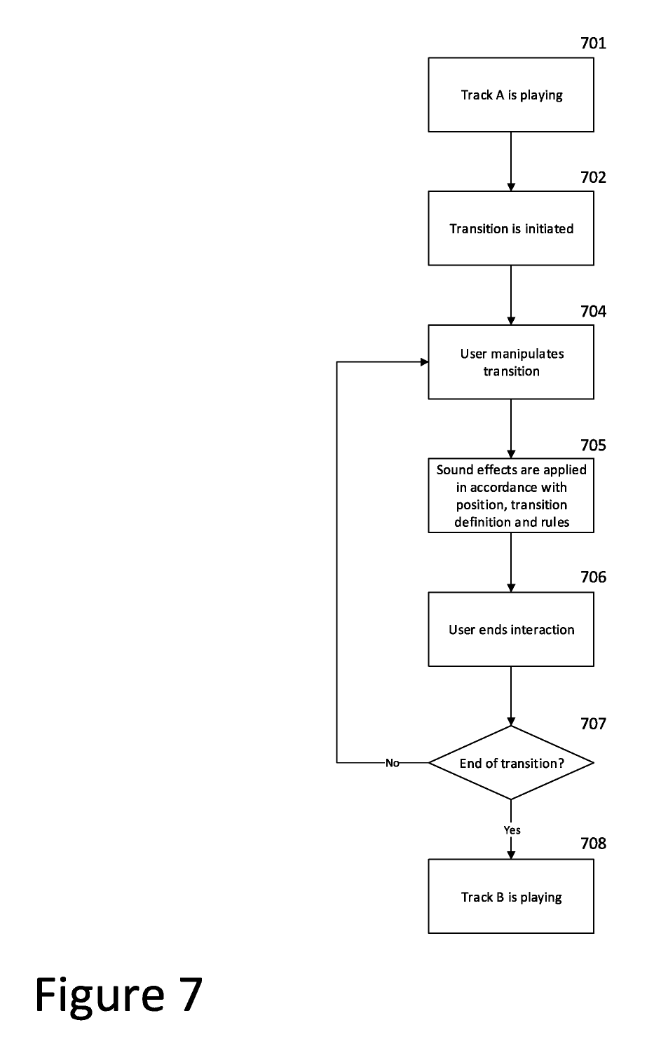

FIG. 7 is a flowchart corresponding to FIG. 6, but illustrating the progression of a transition without time control. For ease of comparison with FIG. 6, the reference numerals have the same final digit for corresponding steps.

Again, prior to initiation of the transition, in step 701, Track A is playing. In step 702 the transition is initiated, for example by user manipulation that makes the control element 405 visible on the display or by user manipulation of the control element if it is already visible.

If there are sound effects that are associated with a position mark with a positional value of 0 in the transition definition, these sound effects will take effect immediately. Apart from that, nothing happens until the user manipulates the transition in step 704 by moving the control element 405. As a result of the user manipulation of the control element 405, the normalized positional value generated by position control module 303 changes. In step 705 sound effects included in the transition definition are applied in accordance with the positional value and any applicable rules. This, of course, includes initiation of playback of Track B. This continues until the user ends the interaction in step 706.

If the user ends the interaction after bringing the transition to its end, corresponding to positional value 1, the transition has completed and Track B will continue playing 708. Likewise, if the user has returned the control element to a position corresponding to positional value 0, the transition may, in some embodiments, be canceled and Track A will continue to play.

However, if the user ends interaction, but it is determined in step 707 that this does not end the transition (i.e. the positional value is somewhere between 0 and 1) the current sound effects will continue to be active with their present parameters (except for sound effects or that themselves have a defined progression toward an end independently of progression of the transition, either inherently or as the result of a rule). This situation will continue until the user again manipulates the transition, effectively bringing the progression back to step 704.

Based on the examples illustrated in FIG. 6 and FIG. 7, respectively, it will be understood that while time controlled transitions as in FIG. 6 always progress towards an end as long as the user does not actively prevent this, transitions that are not time controlled, as in FIG. 7, must be actively brought to a conclusion by the user.

The actual design of a transition definition or the specifics of the code or script language used to create it, are not parts of the invention as such. Typically, a transition may be designed in a studio with equipment that is capable of capturing user input and translating it to commands in a transition definition. Of course, on equipment that gives a disc jockey or producer more freedom to control playback and effects than a transition definition can express (a fader can for example be operated outside what can be defined by a first parameter, a second parameter and a limited set of interpolation functions), the creation of the transition definition may therefore have to include adaptations and approximations. It is also possible to write a script directly in script language and modify it by experimenting with different filters, effects and parameters.

It is in accordance with embodiments of the invention to create transition definitions that are generic in the sense that they can be applied to any combination of audio tracks (i.e. Track A and Track B may be any audio track available to the client application, including one and the same track), but it may also be contemplated to create transition definitions that are specific to Track A, Track B, or both, or that are embedded in or associated with a playlist. Transitions that are associated with specific audio tracks may include information, for example time stamps, that are related to time stamps in the audio track itself and not only to the progression of the transition as such.

Although not part of the invention as such, it may be contemplated to include the ability to create or edit transition definitions in client software implementing the present invention.

After a transition definition has been created it may be shared by being uploaded to a social network server 103 and stored in an associated database 104. As already mentioned, the social network server 103 may be a separate service or it may be part of the services offered by a media server 101. Transition definitions may then be downloaded to client devices 106 to be used in accordance with the invention.

In the present disclosure reference is made to sound effects, filters and audio samples. While there may not be any strict definition in the art of the scope of these various terms, the appended claims should be understood based on the following definitions. A sound effect will include anything that can be invoked by a transition definition or by a user in order to change the presentation of an audio track. Sound effects will include both filters and audio samples, where filters will refer to digital processing of the audio track and audio samples will refer to pre-recorded sound that can be played back in a mix with the audio track. (Of course, hybrids may be contemplated, such as sound effects that process an audio track while at the same time mixing in an audio sample.) According to this terminology, any filter will be considered a sound effect as long as it changes the audio track, and any process that changes the audio track will be thought of as a filter (e.g. also gain adjustment, speed change, etc.).

Similarly, the term transition definition is intended to cover any set of instructions that are consistent with the description presented above. The transition definition may be, but does not have to be, readable by a human user, and in various embodiments it may exist externally to the transition control module 301, or it may be coded into the transition control module 301, for example as part of the source code/program code of an application implementing the invention. Whether the transition definition is implemented as a script that may be loaded or it is permanently coded into the transition control module, or in some other manner, the execution of the transition follows the same principles as those described above with reference to an exemplary embodiment based on scripts that can be loaded from a script library.

Various embodiments of the invention may provide additional functionality to supplement the functionality already described. For example, the sound effects module 302, or alternatively specific script invokable filters, may be able to perform beat and/or tempo synchronization of the two tracks Track A and Track B, as well as corresponding synchronization with selected audio samples.

1. A method of executing a transition from playback of a first audio track to playback of a second audio track on an electronic device, comprising:
during playback of the first audio track, initiating execution of a transition from the first audio track to the second audio track;
executing one or more sound effects referred to in a transition definition in accordance with position marks and parameters included in the transition definition;
receiving a positional value generated from user input representative of a change of a current position in the transition; and
controlling progression of the transition in accordance with the user input.

2. A method according to claim 1, further comprising:
applying rules that determine how the one or more sound effects should be executed based on the user input.

3. A method according to claim 1, further comprising:
generating a user interface window including a transition control element; and
generating the positional value from user manipulation of the transition control element.

4. A method according to claim 3, wherein the transition control element can be moved between positions ranging from a first position representing a beginning of the transition defined in the transition definition to a second position representing an end of the transition defined in the transition definition.

5. A method according to claim 4, wherein the position representing the beginning of the transition is associated with a first positional value of 0, the position representing the end of the transition definition is associated with a second positional value of 1 and intermediate positions are values between 0 and 1 determined by a relative distance to the position representing the beginning of the transition and the position representing the end of the transition; and
the progression of the transition is modified based on a multiplication of a length of the transition as determined by the transition definition with the positional value.

6. A method according to claim 1, wherein the one or more sound effects are chosen from the group consisting of:
filters, which subject an audio track to digital signal processing in accordance with a filter definition and parameters defined in the transition definition; and
audio samples, which are pre-recorded sound effects which can be played back in a mix with one or more of the first audio track or the second audio track.

7. A method according to claim 6, wherein a filter that has been invoked in the transition definition continues to receive parameter values in accordance with one or more rules selected from the group consisting of: no value; closest past value; closest value; closest future value; last specified value; and an interpolated value.

8. A method according to claim 6, wherein playback of an audio sample is determined in accordance with rules selected form the group consisting of: forward; backward normal; backward reversed; loop; and loop when frozen.

9. A method according to claim 1, wherein the transition definition is a script that is stored in a script library and that can be loaded into a transition control module by a script module.

10. A method according to claim 1, wherein the transition definition is coded into program code of a transition control module.

11. A method according to claim 1, wherein the transition progresses in accordance with a particular positional value generated by a clock or a counter counting time units in absence of any positional value generated from user input, the position marks in the transition definition are time stamps, and a position in the transition is a temporal position.

12. A method according to claim 1, wherein the transition progresses in accordance with a particular positional value generated by a counter counting beats of music included in at least one of the first audio track and the second audio track in absence of any positional value generated from user input.

13. A method according to claim 1, wherein the transition definition is defined in one of a human readable script and a binary code.

14. An electronic device configured for playing back audio tracks and executing transitions between tracks in accordance with definitions in a transition definition, comprising:
a transition control module configured to control a transition in accordance with a transition definition including references to sound effects associated with position marks and parameters and by comparing the position marks with a current position;
a sound effects module configured to receive audio data representing audio tracks and to receive effect control data from the transition control module and execute sound effects defined in the effect control data by processing the audio data in accordance with the sound effects defined in the effect control data;
a position control module configured to deliver a positional value representative of the current position in a transition to the transition control module; and
a user interface module capable of receiving user input representative of a modification of the current position in the transition, and of providing the user input to the position control module; wherein
the position control module is further configured to convert the user input to the positional value that can be forwarded to the transition control module; and
the transition control module is further configured to modify progression of the transition in accordance with the positional value.

15. An electronic device according to claim 14, further comprising a rules module configured to provide the transition control module with rules that determine how sound effects should be executed; wherein
the transition control module is further configured to modify application of the sound effects based on the rules received from the rules module and the positional value received from the position control module.

16. An electronic device according to claim 14, wherein the user interface module is further configured to generate a user interface window including a transition control element and to provide a value representative of the current position in the user interface window of the transition control element to the position control module as the user input.

17. An electronic device according to claim 16, wherein the transition control element can be moved between positions ranging from a first position representing a beginning of the transition defined in the transition definition and to a second position representing an end of the transition defined in the transition definition.

18. An electronic device according to claim 17, wherein the position control module is further configured to convert the value provided by the user interface module to a first positional value of 0 when the transition control element is at the position representing the beginning of the transition, to a second positional value of 1 when the transition control element is at the position representing the end of the transition, and intermediate positions are converted to positional values between 0 and 1 determined by a relative position of the transition control element between the position representing the beginning of the transition and the position representing the end of the transition.

19. An electronic device according to claim 14, wherein the sound effects module is further configured to perform digital signal processing of the audio data in order to implement one or more of the sound effects chosen from the group consisting of:
filters, which subject audio data to digital signal processing in accordance with a filter definition and parameters defined in the transition definition; and
audio samples, which are pre-recorded sound effects which can be played back in a mix with other audio data.

20.-25. (canceled)

26. A computer program product including computer readable medium readable by a computing device and including instructions enabling the computing device with a processor to:
during playback of a first audio track, initiate execution of a transition from the first audio track to a second audio track;
execute one or more sound effects referred to in a transition definition in accordance with position marks and parameters included in the transition definition;
receive a positional value generated from user input representative of a change of a current position in the transition; and
control progression of the transition in accordance with the user input.
